(19) United States
(12) Patent Application Publication
(10) Pub. No.: US 2015/0348050 A1
(43) Pub. Date: Dec. 3, 2015

(54) HYBRID CLOUD ENCRYPTION METHOD

(71) Applicant: Avaya, Inc., Santa Clara, CA (US)

(72) Inventors: George Erhart, Loveland, CO (US); Valentine C. Matula, Granville, OH (US); David Skiba, Golden, CO (US)

(73) Assignee: Avaya, Inc., Santa Clara, CA (US)

(21) Appl. No.: 14/293,156

(22) Filed: Jun. 2, 2014

(51) Int. Cl. G06Q 30/00; G06Q 50/00

(52) U.S. Cl. CPC G06Q 30/016; G06Q 50/01; G06Q 2220/00

(57) ABSTRACT

Contact centers receive work items for processing by resources, such as human or automated agents. Social media has become a popular medium to receive work items and communicate with customers. Legal concerns, such as those focused on customer privacy, may limit gathering and/or storing of certain customer data on resources controlled by the contact center or require the deletion of data collected from a revoked prior authorization. Storing at least some data, such as a token, within a customer's social media website allows a contact center to maintain connections, transactions, or other information related to a customer or a specific transaction with a customer as long as the customer and/or social media website chose not to delete the token.

### FIELD OF THE DISCLOSURE

The present disclosure is generally directed toward data storage and more particularly using a social media website.

### BACKGROUND

Currently, social media data is stored in a highly-distributed data storage architecture (e.g., the “cloud”), which may include social media sites (Facebook, Twitter, YouTube, etc.). Access to all relevant social media data, even limited to customers or transactions with the customers, may not be possible or practical. A contact center wishing to maintain customer and customer transaction data, or a portion thereof, may replicate the data as needed in the contact center's data storage. While data storage requirements may make such data storage cumbersome and resource intensive, legal requirements may provide a strict prohibition on any attempt to gather and/or maintain certain data originating from social media websites.

The contact center may also have their own private customer data associated with a customer. When the contact center links to the social media site, such as to communicate with a customer via the social media site, the contact center may be unable to retrieve both sides of the transaction for storage and/or future use. Managing social media site interactions is difficult when the contact center is only able to control half of the data involved in a customer interaction. The contact center typically will find it difficult to match up the social presence of the customer with the customer's contact center presence. Furthermore, without a complete history available, determining what issue, transaction state, or context applies to this interaction can add to the difficulty. The result is delayed service, errors, or repeated questions to catch both sides up on the information from previous interaction(s). As a result, despite the advances in managing customer relationships utilizing social media sites, the ability to implement the advantages may be limited.

### SUMMARY

It is with respect to the above issues and other problems that the embodiments presented herein were contemplated.

In addition to the technical issues associated with accessing and/or storing private data from social media websites, legal requirements often restrict the methods and types of data that may be gathered and/or maintained for a customer. For example, the European Union may mandate the separation of user provided data, such as that hosted on a social media site, and private customer data, such as that provided by a customer to an enterprise. An enterprise utilizing social media to interact with customers, which may include potential customers, prospects, persons expressing an interest (positive, negative, or neutral), etc., may be prevented from integrating social media data and private customer data. Accordingly, there is a need to link contact center data and social media data in a manner acceptable to the contact center, customer, and regulatory agencies.

As disclosed herein with respect to certain embodiments, encrypted data specific to a customer, transaction, etc. may be stored on a social media site that is used by the contact center when interacting with the customer. The data could be a customer ID, transaction, transaction state, preference(s), or other data that pertains to the customer-business relationship. The encryption algorithm may use some specific customer data during key generation to avoid duplication, theft, or spoofing attempts with the data.

In other embodiments, a tag or other identifier serves as a pointer to private data while the tag itself is maintained on the social media site. The tag or pointer may also be encrypted. As a benefit, a customer's social presence on a social media site can be readily associated with private data held by the contact center. The tag may be placed in a post, in a profile, coded in the response to the customer, or other non-contact center controlled area, could be managed in the use or encoding of fonts, sizes, styles, hidden fields, etc. The tag then associates the customer, via the social media site, to private data or a data store of the contact center.

Upon first contact and validation (by an automated and/or human agent) of the customer, an attempt is made to store a token, such as a customer identifier. The token may be encrypted such that the only intended user of the token is the contact center. Content, such as a post, entry in a profile, or other content-bearing aspect of the social media site is selected to host the token. The token may be visible to a casual observer or hidden from view (e.g., maintained as metadata on a social media site).

When contact is made with a previous customer, a search is done for the key in both the profile and transaction. If found, then the information may be loaded for reference by the agent. In addition, by saving and noting where tokens used as keys are stored across several sites, this method and context may be used to display customer information when the customer is engaged in a voice call, chat, email, or other non-social media site interaction.

As a benefit of certain embodiments, the problem of maintaining a rich user context related to social media, without hosting any social media data internally in the contact center, may be provided. This benefit may continue to increase in value as the privacy concerns over social media and monitoring continue to increase.

In a non-limiting example, a customer “likes” a company, causing the company to validate/match the customer account. Once matched, a token in the form of an encrypted value is stored on the social site for reference and is accessible upon a future interaction. For example, Sam engages in a chat over Twitter direct message regarding a flight delay. An encrypted value for Sam (customer/transactional) ID may be retrieved to start the transaction and an encrypted transaction ID may be created and stored as a part of the direct message chain. Sam's ID is attached to the data and the data trails help the contact center manage what has occurred on the premise side. By marking Sam's profile and his communication, linking his encryption key to Sam's customer data at the contact center and dumping his data to an agent, the agent Martha, an agent of the airline, can effectively help Sam with his flight concerns. Martha is assisted with the knowledge that Sam sent four additional Twitter direct messages in the last two months for flight delays. Martha helps Sam with an apologetic demeanor that might not have existed had she not been aware of the previous delays.

Certain embodiments may utilize private/public type keys for encryption/decryption of tokens. Other encryptions means may also be utilized. Additionally, the key may be portable, such that a token may be used across multiple social sites.

As a further benefit, a customer maintains much of their own data with respect to a contact center interactions. For example, if a customer were to purge their Twitter account or even if the purge was limited to all transactions related to a particular company, the company would be limited to their own private data. If legal or other practices require the contact center data to be deleted, the contact center may delete their own records and, if the customer chose to maintain their information related to the contact center on their social media account, it would be at the customer discretion and outside of the technical and/or legal authority of the contact center to maintain or delete such data.

The embodiments disclosed herein may generally, but not exclusively, fall into, at least, one of three parts:

1. Customer token/key creation: Tokens may be encrypted with keys. Tokens and/or keys may be created with standard encryption techniques, subject to country or other locale requirements or restrictions, and performed on demand and stored in the Customer Relationship Management (“CRM”) customer record for reference when needed. The encrypted token may utilize various aspects of the customers social media profile ID, customer social media transition IDs, company CRM assigned ID, or other unique information linking the customer and/or the transaction.

2. Storage of customer tokens inside customer social media: Profile tokens and transaction tokens are two possibilities modes for storage.

a. Profile token: When a customer performs an action to like, follow, attach, etc. based on the facilities of the social network, the customer is generally accepting/approving the company for some level of access or activity. The company is made aware of the new connection through either polling of information, or notification received from social media site. The company may then attempt to match, either automatically or manually, the social customer with an existing customer record. If no match is found, a new record is created and encrypted token created. If a match, encrypted token is accessed. The invention then inserts (e.g., stores) the token in the customer profile on the social media site for reference on a future contact.

The token may be stored in an existing field or a newly created field, depending on the attributes of the social media site. The field may be a public field or a private field depending on the site. The token is not stored in the company controlled data repositories.

b. Transaction token: During a post/comment or other form of messaging interaction (public or private) with a customer, an attempt is made to identify the customer (see, “profile token” above). A transaction token may be created for the specific transaction. The transaction token will be stored in one of the response interactions from the company.

Various methods may be used to minimize the visibility of the token, including storing at the end of a message, storing using html markup language to token hidden, storing on an attribute of the message, or other options that might be developed by social media sites in the future. The interaction token may be created with the CRM customer ID and transaction ID as part of the token and/or key. As above, the transaction token is stored in the social media site and not in company controlled data repositories.

3. Retrieval and usage of token. When a new customer interaction, via a social media website, arrives (e.g., post, comment, or other messaging interaction), the invention will look to see if there is a token previously stored in the transaction and/or customer profile. If no token is found, the creation method, such as the one described above (see #2, above), is executed to create a token. If a token is found, the token is used then used to find the customer CRM record and/or any existing transactions, history, links, and pointers. Next, the transaction will be searched for a transaction token. If not found, one will be created and stored with the next reply. If found, a query for the transaction will be initiated to find the transaction in the CRM data using this token.

As a benefit, tracing of the social media history/data is enabled, without having any social media data stored internally to the company. The information is then made available to either the automated transaction processing and/or as a visual summary to the agent. Traditional contact center transactions (e.g., voice, video, email, chat) may benefit from the enhanced knowledge provided via the token to present information about the social media history of the customer linked through tokens. Implementation of certain features disclosed herein will be enabled based upon specific features and/or modes of operation provided by specific social media sites.

In one embodiment, a method is disclosed, comprising: generating a token that identifies a customer to a contact center; accessing a portion of the social media website associated with the customer; and causing the token to be stored on the portion of the social media website.

In another embodiment, another method is disclosed, comprising: receiving a work item from a customer of a contact center; in response to receiving the work item, attempting to locate a token stored on a social media website; upon locating the token, retrieving the token; processing the work item by a resource of the contact center; updating the token in accord with the work item; and causing the updated token to be stored on the portion of the social media website.

In yet another embodiment, a system is disclosed, comprising: a communication interface; a processor; and wherein the processor is operable to perform: generating a token that identifies a customer to a contact center; accessing, via the communication interface, a portion of the social media website associated with the customer; and causing the token to be stored on the portion of the social media website.

The terms “company” and “contact center” may be used synonymously or differently. A company, as used herein, generally refers to a business enterprise engaged in the sale or offering for sale of goods or services. A contact center is engaged in attending to the needs of the customers and/or potential customers, which may include selling and offering to sell the goods or services of the company. A contact center and a business may be the same business enterprise or different, such as when the contact center is a contractor, division, affiliated company, or otherwise acting on behalf of the company.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine,” “calculate,” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that other aspects of the disclosure can be separately claimed.

### BRIEF DESCRIPTION OF THE DRAWINGS

The present disclosure is described in conjunction with the appended figures:

FIG. 1 depicts a communications system in accordance with embodiments of the present disclosure;

FIG. 2 depicts another aspect of the communication system in accordance with embodiments of the present disclosure;

FIG. 3 depicts a number of illustrative means for storing contact center data on a social media website in accordance with embodiments of the present disclosure;

FIG. 4 depicts the storage of contact center data on a social media website in accordance with embodiments of the present disclosure;

FIG. 5 depicts the use of contact center data stored on a social media website in accordance with embodiments of the present disclosure;

FIG. 6 depicts a process for storing contact center data on a social media website in accordance with embodiments of the present disclosure;

FIG. 7 depicts a first process for using contact center data stored on a social media website in accordance with embodiments of the present disclosure.

FIG. 8 depicts a second process for using contact center data stored on a social media website in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

The identification in the description of element numbers without a subelement identifier, when a subelement identifiers exist in the figures, when used in the plural, is intended to reference any two or more elements with a like element number. A similar usage in the singular, is intended to reference any one of the elements with the like element number. Any explicit usage to the contrary or further qualification shall take precedence.

The exemplary systems and methods of this disclosure will also be described in relation to analysis software, modules, and associated analysis hardware. However, to avoid unnecessarily obscuring the present disclosure, the following description omits well-known structures, components and devices that may be shown in block diagram form, and are well known, or are otherwise summarized.

For purposes of explanation, numerous details are set forth in order to provide a thorough understanding of the present disclosure. It should be appreciated, however, that the present disclosure may be practiced in a variety of ways beyond the specific details set forth herein.

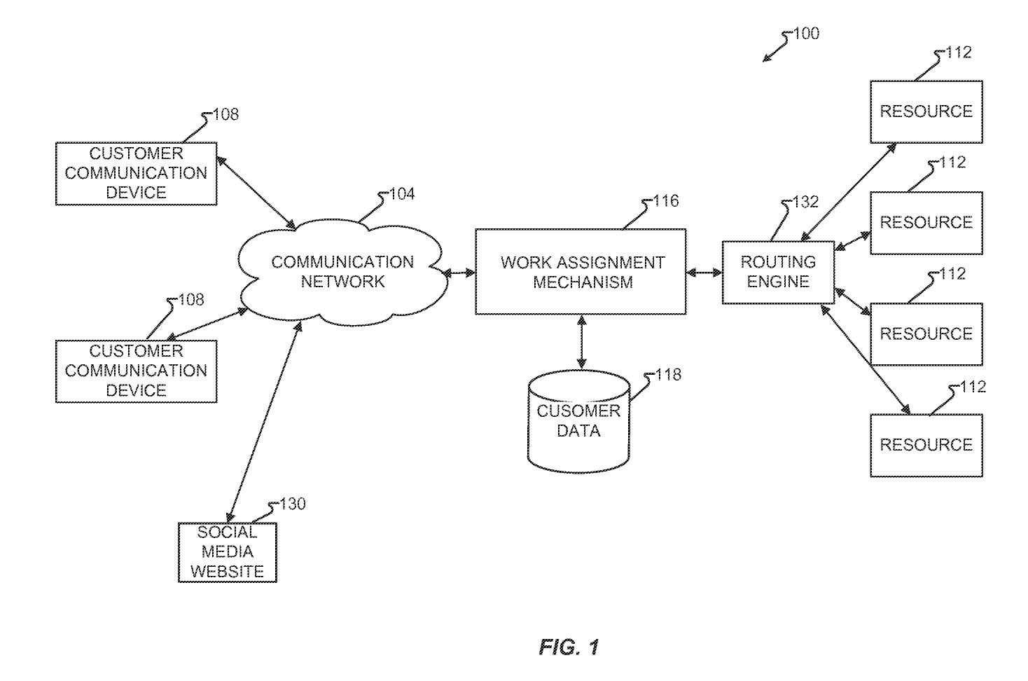

FIG. 1 shows an illustrative communication system 100 in accordance with at least some embodiments of the present disclosure. The communication system 100 may be a distributed system and, in some embodiments, comprises a communication network 104 connecting one or more communication devices 108 to a work assignment mechanism 116, which may be owned and operated by an enterprise administering a contact center in which a plurality of resources 112 are distributed to handle incoming work items (in the form of contacts) from customer communication devices 108.

In other embodiments, work items may be received or pulled from social media website 130. Work items received via social media website may be posts, or similar comment, on a particular forum or company “page” and may further be received or pulled by work assignment mechanism 116. Work items may be pulled as posts on non-company pages, such as an individual page, user group page, common interest page and the like. Posts having a particular keyword, phrase, user, or other aspect may be discovered by work assignment mechanism 116 and retrieved as work items. As social media website 130 takes various forms, also contemplated by the embodiments herein are the various forms of user provided posts and interacting with users. For example, a post may be a comment on a user's own page, a company page, video, image, another user's comment, the same user's comment, or other aspect operable to receive a comment from a user. More specifically, Likes, Tweets, media, comments, endorsements, shares, and other inputs from a user on a social media website 130 may similarly be posts and potentially also be work item and routed to resource 112.

In accordance with at least some embodiments of the present disclosure, the communication network 104 may comprise any type of known communication medium or collection of communication media and may use any type of protocols to transport messages between endpoints. The communication network 104 may include wired and/or wireless communication technologies. The Internet is an example of the communication network 104 that constitutes an Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over IP (VoIP) network, a cellular network, and any other type of packet-switched or circuit-switched network known in the art. In addition, it can be appreciated that the communication network 104 need not be limited to any one network type, and instead may be comprised of a number of different networks and/or network types. As one example, embodiments of the present disclosure may be utilized to increase the efficiency of a grid-based contact center. Examples of a grid-based contact center are more fully described in U.S. patent application Ser. No. 12/469,523 to Steiner, the entire contents of which are hereby incorporated herein by reference. Moreover, the communication network 104 may comprise a number of different communication media such as coaxial cable, copper cable/wire, fiber-optic cable, antennas for transmitting/receiving wireless messages, and combinations thereof.

The communication devices 108 may correspond to customer communication devices. In accordance with at least some embodiments of the present disclosure, a customer may utilize their communication device 108 to initiate a work item, which is generally a request for a processing resource 112. Illustrative work items include, but are not limited to, a contact directed toward and received at a contact center, a web page request directed toward and received at a server farm (e.g., collection of servers), a media request, an application request (e.g., a request for application resources location on a remote application server, such as a SIP application server), and the like. The work item may be in the form of a message or collection of messages transmitted over the communication network 104. For example, the work item may be transmitted as a telephone call, a packet or collection of packets (e.g., IP packets transmitted over an IP network), an email message, an Instant Message, an SMS message, a fax, and combinations thereof. In some embodiments, the communication may not necessarily be directed at the work assignment mechanism 116, but rather may be on some other server in the communication network 104 where it is harvested by the work assignment mechanism 116, which generates a work item for the harvested communication. An example of such a harvested communication includes a social media communication that is harvested by the work assignment mechanism 116 from a social media network or server. Exemplary architectures for harvesting social media communications and generating work items based thereon are described in U.S. patent application Ser. Nos. 12/784,369, 12/706,942, and 12/707,277, filed Mar. 20, 1010, Feb. 17, 2010, and Feb. 17, 2010, respectively, each of which are hereby incorporated herein by reference in their entirety.

The format of the work item may depend upon the capabilities of the communication device 108 and the format of the communication. In particular, work items are logical representations within a contact center of work to be performed in connection with servicing a communication received at the contact center (and more specifically the work assignment mechanism 116). The communication may be received and maintained at the work assignment mechanism 116, a switch or server connected to the work assignment mechanism 116, or the like until a resource 112 is assigned to the work item representing that communication at which point the work assignment mechanism 116 passes the work item to a routing engine 132 to connect the communication device 108 which initiated the communication with the assigned resource 112.

Although the routing engine 132 is depicted as being separate from the work assignment mechanism 116, the routing engine 132 may be incorporated into the work assignment mechanism 116 or its functionality may be executed by the work assignment engine 120.

In accordance with at least some embodiments of the present disclosure, the communication devices 108 may comprise any type of known communication equipment or collection of communication equipment. Examples of a suitable communication device 108 include, but are not limited to, a personal computer, laptop, Personal Digital Assistant (PDA), cellular phone, smart phone, telephone, or combinations thereof. In general each communication device 108 may be adapted to support video, audio, text, and/or data communications with other communication devices 108 as well as the processing resources 112. The type of medium used by the communication device 108 to communicate with other communication devices 108 or processing resources 112 may depend upon the communication applications available on the communication device 108.

In accordance with at least some embodiments of the present disclosure, the work item is sent toward a collection of processing resources 112 via the combined efforts of the work assignment mechanism 116 and routing engine 132. The resources 112 can either be completely automated resources (e.g., Interactive Voice Response (IVR) units, processors, servers, or the like), human resources utilizing communication devices (e.g., human agents utilizing a computer, telephone, laptop, etc.), or any other resource known to be used in contact centers.

As discussed above, the work assignment mechanism 116 and resources 112 may be owned and operated by a common entity in a contact center format. In some embodiments, the work assignment mechanism 116 may be administered by multiple enterprises, each of which has their own dedicated resources 112 connected to the work assignment mechanism 116.

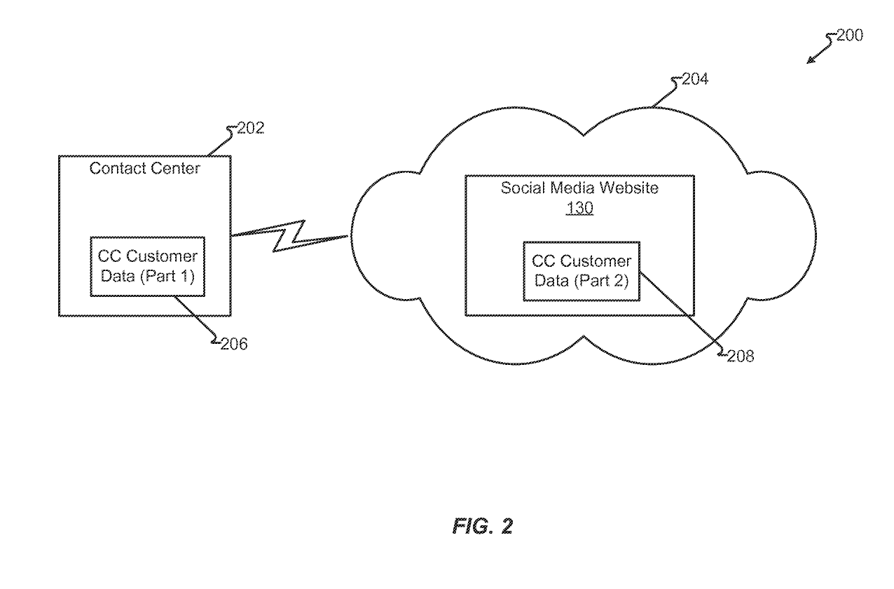

FIG. 2 shows second illustrative embodiment 200 of a communication system 100 in accordance with at least some embodiments of the present disclosure. In one embodiment, contact center 202 maintains a first part 206 of customer data. Cloud 204 may be a public network (e.g., Internet) or other repository outside of the direct control of contact center 202, including social media website 130 or a plurality thereof. Social media website 130 is then caused by contact center 202 to maintain a second part 208 of customer data.

In another embodiment, a customer maintains a presence on social media website 130, which may include, but is not limited to, a profile, contact information, biographic information, interest, connections to other individuals, connections to groups, connections to corporate entities, comments, media, etc. In turn, the connections, relationships, and other interest may cause artifacts to be placed on social media website 130 that are explicitly or implicitly associated with the customer. For example, a content provider (e.g., individual, group, company, etc.) may cause certain items to be placed on a “wall” (e.g., a portion of the website associated with items of interest, news, etc.), such as when social media website 130 is Facebook, Pinterest, Twitter, etc. In another example, a content provider may explicitly place an item on social media website 130 to be associated with the customer, such as, “tagging” a photograph of the customer and/or sending a message and/or media file to the customer.

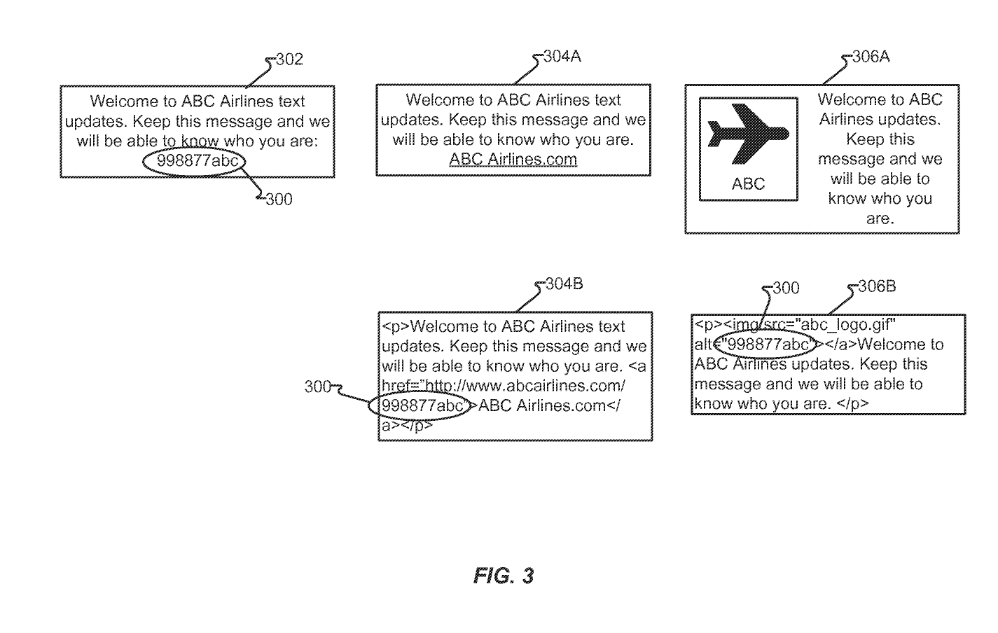

The presence of the second part 208 is at the discretion of the customer and/or the social media website. As a benefit, if the customer has a portion of social media website 130, they may delete their presence and sever the relationship between themselves and social media website 130. As a result, the preservation of any data within second part 208 is outside of the control of contact center 202. If any data is maintained in second part 208 in a manner contrary to a legal requirement to remove it, the consequences would befall the party hosting the data, such as social media website 130. In another example, if the customer had a connection to a business enterprise on social media website 130 and decided to purge only the relationship to the enterprise, any data maintained in second part 208 would be removed by the customer and/or social media website 130 and any failure to remove said data would be outside of the control of contact center 202. The storage of data in second part 208 is variously embodied and discussed more completely with respect to FIG. 3. However, if data was removed in first part 206 and, for example, the customer later had a reason to contact the business, certain information may be accessible from second part 208.

FIG. 3 shows a number of illustrative embodiments whereby contact center 202 data may be stored on social media website 130, in second part 208. In one embodiment, token 300 is an unencrypted identifier of a particular customer. The contact center 202 (e.g., ABC Airlines itself or an affiliated organization), may receive a future communication or other work task and find post 302 having token 300. As a result, social media website 130 stores the identifier.

In another embodiment, token 300 is encrypted. Encrypting token 300 may be beneficial to protect certain information from being revealed and/or misused. Token 300 may be embodied as a few characters (e.g., token 300) or many characters, digits, bits, etc. Token 300 may include just a few characters on up to nearly limitless number of characters, such as to incorporate a transaction, transaction history, customer details, or other information which may be selected as a matter of design choice.

The specific means by which token 300 is caused to be stored in second part 208 is variously embodied and may means by which visible, not-presented, and/or hidden information is provided to social media website 130. In one embodiment, post 304 comprises presented portion 304A and encoded portion 304B. Encoded portion 304B includes token 300 in a URL hidden, or at least not displayed, in presented portion 304A. In yet another embodiment, post 306 comprises presented portion 306A and encoded portion 306B. Encoded portion 304B includes token 300 in alternative text for an image. And, in yet another embodiment, token 300 may be placed in a field designated by social media website 130, accessible by contact center 202 and may, or may not, be visible to one or more of the customer associated with token 300, the public, or other entities. In other embodiments, token 300 may be stored with respect to fonts, styles, style sheets, or other metadata and/or hidden fields.

While token 300 may incorporate data associated with a customer and/or a transaction with the customer, token 300 may be a pointer to data stored outside of the social media website. In certain embodiments, the data may reside in customer records 118 or other data repository, including other social media websites.

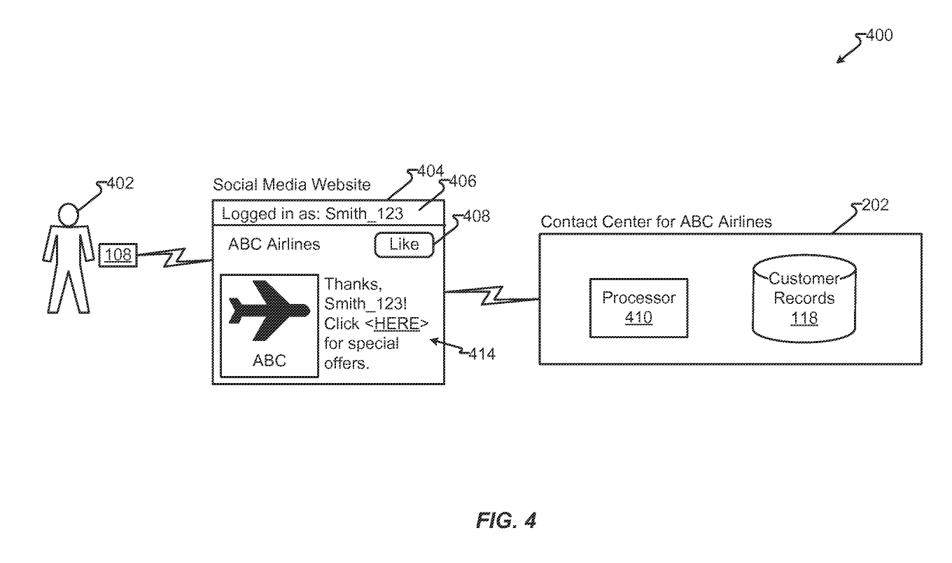

FIG. 4 shows an illustrative embodiments whereby contact center 202 data may be stored on social media website 130, in second part 208. In one embodiment, customer 402 via customer communication device 108, interacts with portion 404 of social media website 130. Content within portion 404 is generally under the control of customer 402, and to some degree the operators of social media website 130, such as to place ads and select content. As well to support the removal of any content which may be in violation of the terms of use between customer 402 and social media website 130. Portion 404 may be commonly referred to as the “page” for customer 402. Portion 404 may include profile information as well as content provided, endorsed, or otherwise determined by customer 402.

Customer 402 selected connection 408 associated with a business entity (e.g., ABC Airlines). Generally, such an endorsement is an agreement to allow some interaction between the endorser (customer 402) and the endorsee (e.g., ABC Airlines). Connection 408 may be an endorsement (e.g, “like,” “share,” etc.) or a more express desire to connect (e.g., “follow,” “friend”—as a verb, etc.) or other act whereby customer 402 agrees to the interaction with the endorsee.

In another embodiment, contact center 202 becomes aware of connection 408 by polling social media website 404 and/or receiving notifications from social media website 130. Contact center 202 may attempt to identify customer 402 with respect to existing entries in customer records 118 or other data repository of customer data of contact center 202. Processor 410 may then create new token 300 identifying customer 402 as a new customer or, if customer 402 is determined be an existing customer, token 300 may indicate the prior relationship. For example, a customer number or other indicia of the relationship may be used as token 300. Additionally, token 300 may be encrypted.

Token 300 may be placed directly into portion 404. Alternatively, response 414 is formatted by resource 112 incorporating token 300. Other means of incorporating the token are discussed more fully with respect to FIG. 3.

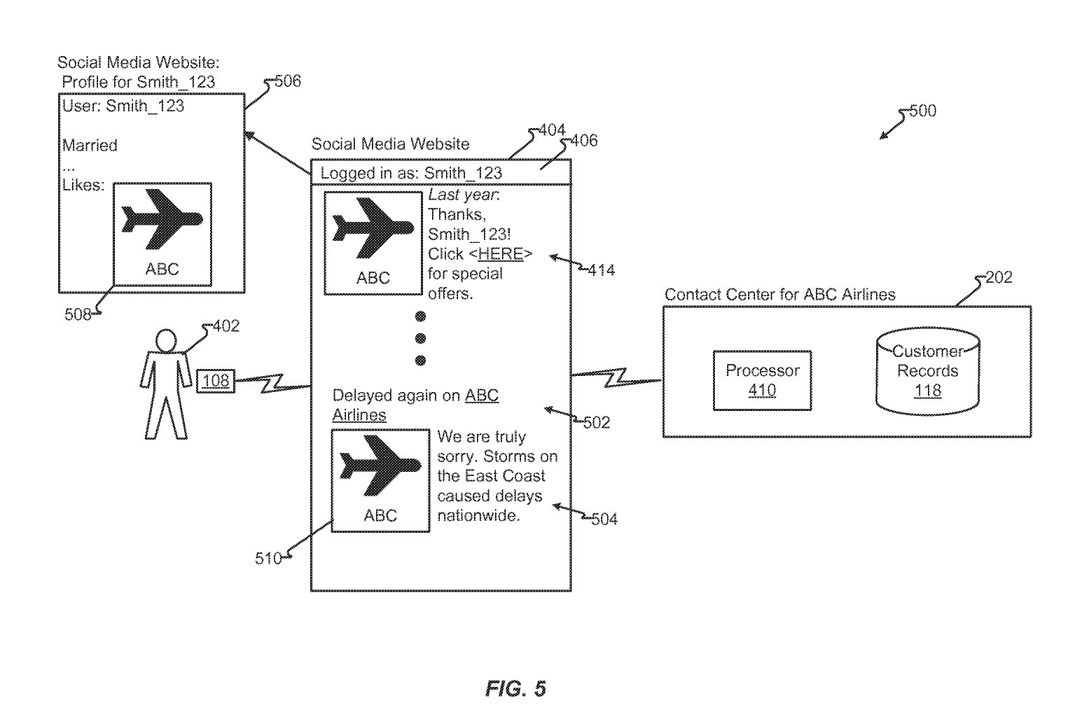

FIG. 5 shows an illustrative embodiments whereby contact center 202, stored on social media website 130, in second part 208, may be used to process a work item. In one embodiment, customer 402, via customer device 108, causes a work item to be created. The work item may be created directly on portion 404 of social media website. For example, user 402 may create post 502 identifying an entity (e.g., ABC Airlines) monitored by contact center 202 and/or receiving notifications of posts from social media website 130.

The work item is processed by contact center 202, such as according to at least some of the embodiments discussed with respect to FIG. 1. Processor 410 may access a prior response 414 to access token 300 therein to identify a prior transaction with customer 402 or to determine the identity of customer 402 with respect to one or more entries in customer records 118. In another embodiment, processor 410 may cause profile page 506 to be accessed having a previously placed token 300, such as embedded in the code for image 508, a link, or other placement.

As a benefit, the identity of customer 402, a transaction with customer 402, or other artifact of the relationship between customer 402 and contact center 202 may be determined, without requiring access to customer records 118. Resource 112 may then respond to the work item.

In one embodiment, processor 410 may then cause a reply post 504 to be posted. The context of post 504 may be determined, at least in part, on prior history with customer 402 and/or prior transactions with customer 402 within the realm of social media 130 and/or other communications mediums. Post 504 may further include an updated token, such as one embedded within image 510.

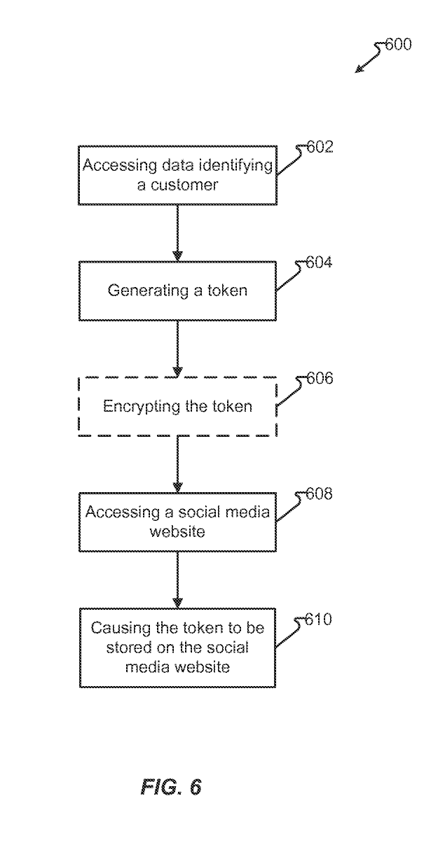

With reference now to FIG. 6, process 600 will be described in according with embodiments of the present disclosure. In one embodiment, processor 410 performs step 602 to access data identifying customer 402. Step 602 may identify the customer 402 by a transaction or a combination thereof. For example, customer 402 may be identifying in step 602 as a specific individual who is known to contact center 202, such as by having associated records in customer records 118. In another example, customer 402 may be identified by a transaction, such as asking a question on social media website 130 or by contacting contact center 202 directly, such as via a telephone call, email, or other means. An example of a combination of individual and transaction identification includes, identification of a customer on one social media website 130 and a transaction on a second social media website 130.

Step 604 then generates a token. The specific content of the token is a matter of design choice and may comprise a customer identifier, a transaction identifier, or other identifier. Optionally, step 606 may encrypt the token. Encryption may be performed using known means, such as private/public key encryption. Step 608 accesses a social media website and step 610 causes the token to be stored on the social media website in a manner known to the contact center. For example, as a hidden field of a HTML message, steganographic image, or a visible image, text, or link, or other means whereby the token may be preserved in the social media site.

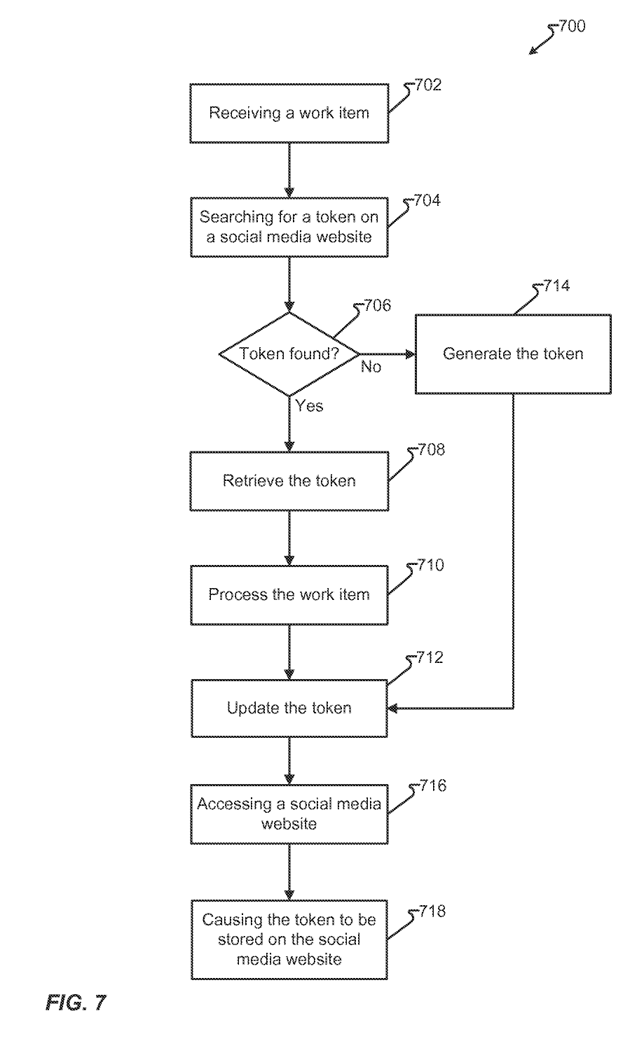

With reference now to FIG. 7, process 700 will be described in according with embodiments of the present disclosure. In one embodiment, step 702 receives a work item in contact center 130. The work item may be presented to contact center 202 (e.g., the customer calls, emails, posts on social media website 130, etc.). Alternatively, the work item may be received via polling or other searching for potential work items (e.g., comments on social media website 130). Step 704 searches for token 300 on social media website 130.

In one embodiment, the work item is received via a particular social media website 130 and the same social media website 130 is searched in step 704. Optionally, one or more additional social media websites 130 may be searched in step 704, such as when token 300 is not located on a first social media website 130. In another embodiment, the work item is not received via social media website 130 and step 704 searches one or more social media websites 130 for token 300.

Step 706 determines if the token has been found. If yes, processing continues to step 708. If not, processing continues to step 714. Step 708 retrieves the token. Step 710 processes the work item, such as by one or more of resources 112. Step 712 updates the token with respect to the work item. Step 716 then accesses the social media website and step 718 causes the updated token to be stored in the social media website. If step 706 determined to be false, step 714 generates the token. Optionally, step 714 and/or step 712 encrypts the token and/or step 710 decrypts the token.

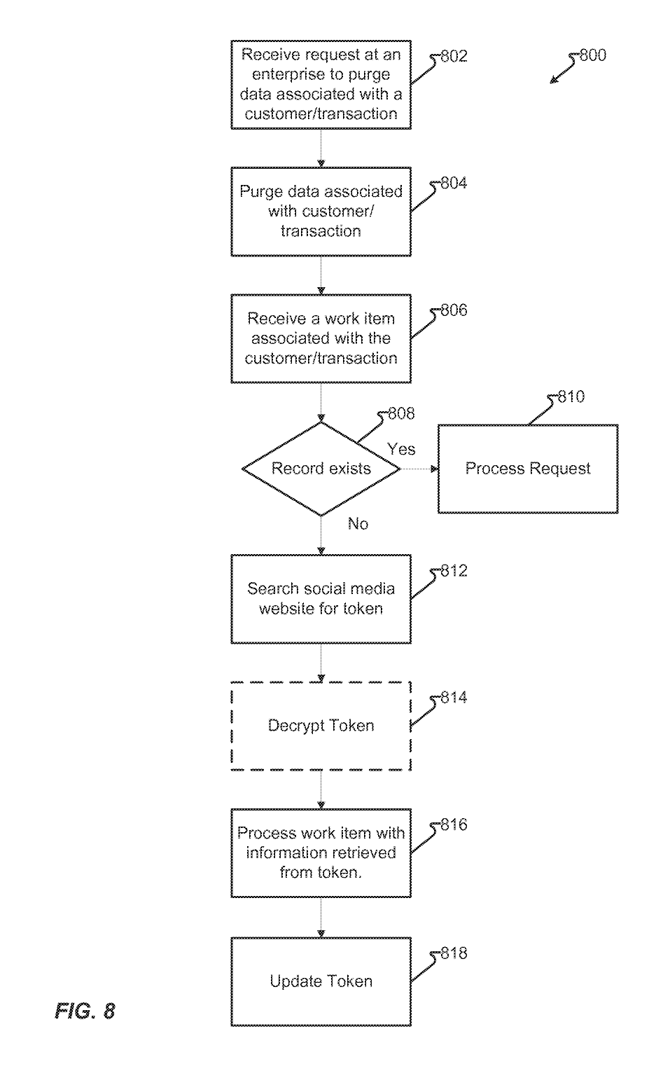

With reference now to FIG. 8, process 800 will be described in according with embodiments of the present disclosure. In one embodiment, step 802 receives a request to purge data. The request may be with respect to all data associated with a customer (e.g., a “forget me” request) or with respect to a particular transaction. Step 804 complies with the request received in step 802. In certain embodiments, purging records in step 804 causes the records to be removed for all aspects of the enterprise, except for those records maintained as a matter of law and which may have access to such records restricted to compliance with requests from authorized regulatory agencies. For example, an enterprise receiving a “forget me” request may be required to purge all marketing data associated with the request but maintain certain financial records for a period of time, such as may be required to comply with tax recordkeeping regulations or other regulatory requirements.

Step 806 receives a work item associated with the customer and/or the transaction. For example, a customer may have decided to terminate the relationship with the enterprise and causes step 802 to request the customer's records be purged from the enterprise. Step 804 may have complied and purged all records or just the records related to the work item. At some period of time later, which could be almost instantly or many years later, the customer creates a work item in step 806. For example, a customer may request step 802 purge their records with a particular enterprise, the enterprise complies in step 804, and the customer realizes they had intended to have records purged from a different enterprise. Accordingly, the work item may be to recover all records or particular records and/or to reestablish the customer-enterprise relationship. In another example, a customer may have caused records to be purged in step 802, which were complied with by step 804. After some time, perhaps years later, the customer may create a work item in step 806 to reestablish the relationship with the enterprise (e.g., the enterprise changed a policy the customer found objectionable was rescinded, etc.) and/or recover a particular transaction (e.g., a receipt for a purchase made years ago to facilitate the customer's warranty claim).

Step 808 determines if the record exists. Executing step 808 may be necessary, such as when step 804 has not yet executed or not executed completely. For example, purge request 802 may have an associated grace period during which records may be retained. If step 806 receives the work item prior to the purging of the records, step 808 may determine the record exists and cause the work item to be processed by step 810, such as by using the still-retained records.

Purge 804 may have removed, or otherwise cause to be inaccessible, the knowledge that a customer/transaction ever existed within the enterprise. In other embodiments, step 808 may be determined by a accessing a limited record indicating the records did exist at one time (e.g., “Customer #123—records purged”). In other embodiments the records may be entirely absent and a search is required. If the search does turn up the records (e.g., the work item was not associated with a customer/transaction who previously requested a purging of records), step 810 processes the request. If the records are not found or otherwise not available, processing continues to step 812.

Step 812 searches one or more social media websites for the token and the token is retrieved. If encrypted, step 812 decrypts the token. The work item is then processed in step 816. Step 818 may then update the token to reflect the work item. If such a request is also associated with a revocation of the purge request, the enterprise may being maintaining records as well.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A method, comprising:
generating a token that identifies a customer to a contact center;
accessing a portion of the social media website associated with the customer; and
causing the token to be stored on the portion of the social media website.

2. The method of claim 1, further comprising encrypting the token prior to causing the token to be stored on the portion of the social media website.

3. The method of claim 1, wherein the step of causing the token to be stored on the portion of the social media website, comprises causing the token to be stored on the portion of the social media website comprising a profile section of the social media website for the customer.

4. The method of claim 1, wherein the token further identifies a transaction between the customer and the contact center.

5. The method of claim 4, wherein the step of causing the token to be stored on the portion of the social media website, further comprises causing the token to be stored on the portion of the social media website comprising a transaction section of the social media website for the customer.

6. The method of claim 1, wherein generating the token further comprises:
receiving a work item in a contact center;
in response to receiving the work item, retrieving the token from the portion of the social media website; and
modifying the token with updated content in accord with the work item.

7. The method of claim 1, wherein the step of causing the token to be stored on the portion of the social media website, further comprises causing the token to be stored on the portion of the social media website comprising a hidden field of the social media website for the customer.

8. A method, comprising:
receiving a work item from a customer of a contact center;
in response to receiving the work item, attempting to locate a token stored on a social media website;
upon locating the token, retrieving the token;
processing the work item by a resource of the contact center;
updating the token in accord with the work item; and
causing the updated token to be stored on the portion of the social media website.

9. The method of claim 8, further comprising, upon not locating the token, generating the token in accord with the work item.

10. The method of claim 9, wherein the received work item is received via a source of work items other than the social media website.

11. The method of claim 8, wherein causing the updated token to be stored on the portion of the social media website, comprises causing the updated token to be stored in a profile section of the social media website associated with the customer.

12. The method of claim 8, wherein causing the updated token to be stored on the portion of the social media website, comprises causing the updated token to be stored in a transaction section of the social media website associated with the customer.

13. The method of claim 8, further comprising, upon retrieving the token, decrypting the token.

14. The method of claim 8, wherein the step of updating the token, further comprises, encrypting the token.

15. A system, comprising:
a communication interface;
a processor; and
wherein the processor is operable to perform:
generating a token that identifies a customer to a contact center;
accessing, via the communication interface, a portion of the social media website associated with the customer; and
causing the token to be stored on the portion of the social media website.

16. The system of claim 15, wherein the processor is further operable to encrypt the token prior to causing the token to be stored on the portion of the social media website.

17. The system of claim 15, further comprising:
a resource of the contact center, wherein the resource is operable to receive work items via the communication interface and process the work item; and
wherein the processor is operable to generate the token in accord with the work item.

18. The system of claim 17, wherein the processor if further operable to cause the token to be stored in a portion of the social media website associated with transactions of the customer.

19. The system of claim 17, wherein the processor is further operable to:
retrieve, via the communication interface, the token from the portion of the social media website associated with the customer; and
wherein generating the token comprises generating an updated token in accord with the work item.

20. The system of claim 15, wherein the processor is operable to encrypt the token prior to causing the token to be stored on the portion of the social media website.
